(19) United States
(12) Patent Application Publication
(10) Pub. No.: US 2026/0005526 A1
(43) Pub. Date: Jan. 1, 2026

(54) POWER SUPPLY SYSTEM

(71) Applicant: TOYOTA JIDOSHA KABUSHIKI KAISHA, Toyota-shi (JP)

(72) Inventor: Jinwoo KIM, Toyota-shi (JP)

(73) Assignee: TOYOTA JIDOSHA KABUSHIKI KAISHA, Toyota-shi (JP)

(21) Appl. No.: 19/044,075

(22) Filed: Feb. 3, 2025

(30) Foreign Application Priority Data
Jul. 1, 2024 (JP) 2024-106322

(51) Int. Cl. H02J 7/00; B60L 53/16; B60L 53/62

(52) U.S. Cl. CPC H02J 7/0024; B60L 53/16; B60L 53/62; H02J 7/0048

(57) ABSTRACT

The power supply system includes: a first battery and a second battery; a motor having a three-phase coil; a first inverter connected to the first battery via the first positive line and the negative line and connected to one end side of the three-phase coil; a second inverter connected to the second battery via the second positive line and the negative line and connected to the other end side of the three-phase coil; a charging connector connected to the first positive line and the negative line and electrically connectable to the charging equipment; and a control device that turns on and fixes one upper arm of the first inverter and the second inverter and controls duty of the other upper arm and the lower arm during parallel charging of the first battery and the second battery using electric power from the charging equipment.

### CROSS-REFERENCE TO RELATED APPLICATION

This application claims priority to Japanese Patent Application No. 2024-106322 filed on Jul. 1, 2024. The disclosure of the above-identified application, including the specification, drawings, and claims, is incorporated by reference herein in its entirety.

### BACKGROUND

### 1. Technical Field

The present disclosure relates to a power supply system.

### 2. Description of Related Art

Hitherto, there has been proposed a power supply system including a power storage device and an inlet connected to a positive line and a negative line that connect the power storage device and a power control unit (PCU) that drives a motor (see, for example, Japanese Unexamined Patent Application Publication No. 2019-118221 (JP 2019-118221 A)). The above power storage device includes a first battery, a second battery, and a switching relay capable of switching a first state in which the first battery and the second battery are connected in series and a second state in which the first battery and the second battery are connected in parallel.

### SUMMARY

In recent years, a power supply system includes a first battery, a second battery, and a charging connector. There is devised a power supply system that can perform parallel charging that charges the first battery via a first charging path and charges the second battery via a second charging path using electric power from charging equipment connected to the charging connector. In such a power supply system, there is a possibility that the charging current for the first battery and the charging current for the second battery relatively largely deviate from each other during the parallel charging.

The power supply system of the present disclosure can suppress the relatively large deviation between the charging current for the first battery and the charging current for the second battery during the parallel charging.

The power supply system of the present disclosure adopts the following measures.

The power supply system of the present disclosure is a power supply system including a first battery and a second battery. The power supply system includes:
a motor including a three-phase coil;
a first inverter connected to the first battery via a first positive line and a negative line and connected to one end side of the three-phase coil;
a second inverter connected to the second battery via a second positive line and the negative line and connected to the other end side of the three-phase coil;
a charging connector connected to the first positive line and the negative line and electrically connectable to charging equipment; and
a control device configured to, during parallel charging for charging the first battery and the second battery with electric power from the charging equipment, fix an upper arm of one of the first inverter and the second inverter to an ON state and perform duty control on an upper arm and a lower arm of the other of the first inverter and the second inverter.

The power supply system of the present disclosure includes the motor including the three-phase coil, the first inverter, the second inverter, and the charging connector. The first inverter is connected to the first battery via the first positive line and the negative line and connected to one end side of the three-phase coil. The second inverter is connected to the second battery via the second positive line and the negative line and connected to the other end side of the three-phase coil. The charging connector is connected to the first positive line and the negative line and electrically connectable to the charging equipment. The power supply system may perform the parallel charging for charging the first battery and the second battery with the electric power from the charging equipment. At this time, the upper arm of one of the first inverter and the second inverter is fixed to the ON state (the lower arm is fixed to an OFF state) and the duty control is performed on the upper arm and the lower arm of the other of the first inverter and the second inverter. Therefore, the electric power from the charging equipment can be stepped down by the first inverter and the motor and supplied to the second battery, or can be stepped up by the motor and the second inverter and supplied to the second battery. Thus, when the first inverter and the second inverter are controlled more appropriately, it is possible to suppress the relatively large deviation between the charging current for the first battery and the charging current for the second battery.

In the power supply system of the present disclosure, the control device may be configured to, during the parallel charging, set a minimum value of each of first allowable input power of the first battery and second allowable input power of the second battery as common requested power of the first battery and the second battery, set a double of the common requested power as total requested power, request the charging equipment for the total requested power or a total requested current that is based on the total requested power, and control the first inverter and the second inverter using the common requested power or a current command for the second battery that is based on the common requested power. Thus, it is possible to suppress the relatively large deviation between the charging current for the first battery and the charging current for the second battery more appropriately.

In the power supply system of the present disclosure, the control device may be configured to, during the parallel charging, fix the upper arm of the second inverter to the ON state (fix the lower arm to the OFF state) and perform the duty control on the upper arm and the lower arm of the first inverter when a voltage of the first battery is higher than a voltage of the second battery, and fix the upper arm of the first inverter to the ON state (fix the lower arm to the OFF state) and perform the duty control on the upper arm and the lower arm of the second inverter when the voltage of the first battery is lower than the voltage of the second battery. Thus, it is possible to suppress the relatively large deviation between the charging current for the first battery and the charging current for the second battery more appropriately.

In the power supply system of the present disclosure, a positive terminal of the first battery may be connected to the first positive line.

A negative terminal of the second battery may be connected to the negative line.

The power supply system may further include a series line, a series relay, a parallel line, a first parallel relay, and a second parallel relay. The series line may connect a negative terminal of the first battery and a positive terminal of the second battery. The series relay may be attached to the series line. The parallel line may connect the series line at a position closer to the first battery than the series relay and the negative line. The first parallel relay may be attached to the parallel line. The second parallel relay may be attached to the second positive line.

In the parallel charging, the series relay may be turned off and the first parallel relay and the second parallel relay may be turned on to connect the first battery and the second battery in parallel as viewed from the charging connector, and the first battery and the second battery may be charged with the electric power from the charging equipment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a power supply system 10 and a charging station 80 according to an embodiment of the present disclosure;

FIG. 2 is an explanatory diagram showing a current flow during parallel charging; and

FIG. 3 is a flow chart illustrating a process routine executed by the system ECU 50.

### DETAILED DESCRIPTION OF EMBODIMENTS

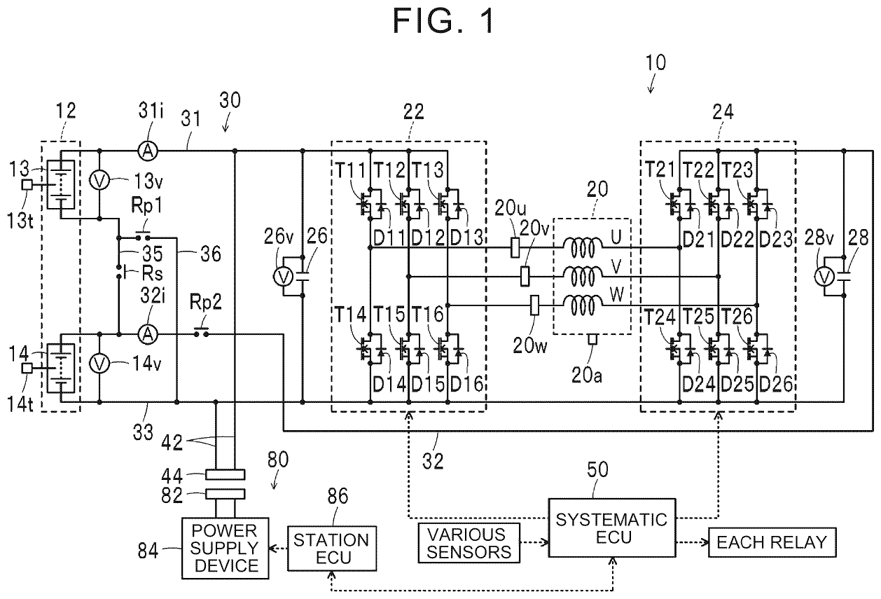

Embodiments for carrying out the present disclosure will be described with reference to the drawings. FIG. 1 is a schematic configuration diagram of a power supply system 10 and a charging station 80 according to an embodiment of the present disclosure. The power supply system 10 is mounted on a battery electric vehicle or a hybrid electric vehicle. A power supply system 10, a battery 12, a motor 20, a first inverter 22, a second inverter 24, a switching circuit 30, a charging circuit 40, and a system electronic control unit (hereinafter referred to as “system ECU”) 50 as a control device are provided. The power supply system 10 is capable of charging the battery 12 using electric power from a charging station 80 provided at a home, a charging station, or the like.

The battery 12 includes a first battery 13 and a second battery 14 as a first battery and a second battery. The first battery 13 and the second battery 14 are each configured as, for example, a lithium-ion secondary battery or a nickel-hydrogen secondary battery whose rated voltage is slightly lower than the first voltage Vs1 (for example, 400 V). In the embodiment, the first battery 13 and the second battery 14 have the same specifications. The positive terminal of the first battery 13 is connected to the first positive line 31, and the negative terminal of the second battery 14 is connected to the negative line 33. The negative terminal of the first battery 13 is connected to the positive terminal of the second battery 14 via the series line 35. A series relay Rs is attached to the series line 35. Therefore, the first battery 13 and the second battery 14 are connected in series to each other by turning on the series relay Rs.

The motor 20 is configured as a three-phase AC motor having, for example, a rotor in which a permanent magnet is embedded in a rotor core, and a stator in which a three-phase (U-phase, V-phase, and W-phase) coil is wound around the stator core. The first inverter 22 includes six transistors T11 to T16 as switching elements, and six diodes D11 to D16 connected in parallel to each of the six transistors T11 to T16. The transistors T11 to T16 are arranged in pairs so as to be source-side and sink-side with respect to the first positive line 31 and the negative line 33, respectively. Each of the connecting points of the two transistors that form a pair of the transistors T11 to T16 is connected to one end of a three-phase (U-phase, V-phase, and W-phase) coil of the motor 20. A smoothing first capacitor 26 is connected to the first positive line 31 and the negative line 33. Like the first inverter 22, the second inverter 24 includes six transistors T21 to T26 as switching elements and six diodes D21 to D26. The transistors T21 to T26 are arranged in pairs so as to be source-side and sink-side with respect to the second positive line 32 and the negative line 33, respectively. Each of the connecting points of the two transistors that are the pair of the transistors T21 to T26 is connected to the other end of the three-phase (U-phase, V-phase, and W-phase) coil of the motor 20. A smoothing second capacitor 28 is connected to the second positive line 32 and the negative line 33. Hereinafter, the transistors T11 to 13, T21 to T23 of the first and second inverters 22 and 24 may be referred to as an “upper arm”, and the transistors T14 to T16, T24 to T26 may be referred to as a “lower arm”.

In addition to the first positive line 31, the second positive line 32, the negative line 33, the series line 35, and the series relay Rs, the switching circuit 30 includes a parallel line 36, a first parallel relay Rp1, and a second parallel relay Rp2. The parallel line 36 connects the negative terminal of the first battery 13 and the negative line 33. The first parallel relay Rp1 is attached to the parallel line 36. The second parallel relay Rp2 is attached to the second positive line 32.

The charging circuit 40 includes a charging line 42 connected to the first positive line 31 and the negative line 33, and a charging connector 44 connected to the charging line 42. The charging connector 44 is configured to be connectable to the station connector 82 of the charging station 80.

The system ECU 50 includes a CPU, a ROM, RAM, a flash memory, an input/output port, a microcomputer having a communication port, various driving circuits, and various logic IC. The system ECU 50 receives signals from various sensors. Examples of the various sensors include a voltage sensor 13v that detects a voltage Vb1 of the first battery 13, and a temperature sensor 13t that detects a temperature Tb1 of the first battery 13. Further, a voltage sensor 14v for detecting the voltage Vb2 of the second battery 14 and a temperature sensor 14t for detecting the temperature Tb2 of the second battery 14 are exemplified. Further, a rotational position sensor 20a for detecting the rotational position of the rotor of the motor 20, and current sensors 20u, 20v, 20w for detecting currents Iu, Iv, Iw flowing in each phase (U-phase, V-phase, and W-phase) of the motor 20 are exemplified.

Note that a voltage sensor 26v for detecting the voltage VH of the first capacitor 26 and a voltage sensor 28v for detecting the voltage VL of the second capacitor 28 are also exemplified. Further, a current sensor 31i for detecting a current Ip1 flowing through the first positive line 31 and a current sensor 32i for detecting a current Ip2 flowing through the second positive line 32 are also exemplified. When the series relay Rs is in the off-state and the first parallel relay Rp1 and the second parallel relay Rp2 are in the on-state, that is, the first battery 13 is connected to the first positive line 31 and the negative line 33, and the second battery 14 is connected to the second positive line 32 and the negative line 33 in some cases. At this time, the current Ip1 flowing through the first positive line 31 is equal to the current flowing through the first battery 13, and the current Ip2 flowing through the second positive line 32 is equal to the current flowing through the second battery 14. Further, when the series relay Rs is in the ON state and the first parallel relay Rp1 and the second parallel relay Rp2 are in the OFF state, that is, the first battery 13 and the second battery 14 are connected in series in some cases. At this time, the current Ip1 flowing through the first positive line 31 is equal to the current flowing through the first battery 13 and the second battery 14.

The system ECU 50 calculates the power storage ratios SOC1, SOC2, the open-circuit voltages OCV1, OCV2, and the allowable input powers Win1, Win2 of the first battery 13 and the second battery 14. The power storage ratios SOC1, SOC2 are calculated, for example, based on the integrated value of the current Ip1 (current flowing through the first battery 13) flowing through the first positive line 31 and the integrated value of the current Ip2 (current flowing through the second battery 14) flowing through the second positive line 32 when the series relay Rs is in the off state and the first parallel relay Rp1 and the second parallel relay Rp2 are in the on state. Note that the power storage ratios SOC1, SOC2 are calculated based on, for example, the integrated value of the current Ip1 (the current flowing through the first battery 13 and the second battery 14) flowing through the first positive line 31 when the series relay Rs is in the ON state and the first parallel relay Rp1 and the second parallel relay Rp2 are in the OFF state. The open-circuit voltages OCV1, OCV2 are derived, for example, by applying the power storage ratios SOC1, SOC2 to a map determined in advance by experimentation, analysis, machine-learning, or the like as a relation between the power storage ratios SOC1, SOC2 and the open-circuit voltages OCV1, OCV2. The allowable input powers Win1, Win2 are derived, for example, by applying the power storage ratios SOC1, SOC2 and the temperatures Tb1, Tb2 to a predetermined map. The map is determined in advance by experimentation, analysis, machine-learning, or the like as a relation between the power storage ratios SOC1, SOC2, the temperatures Tb1, Tb2, and the allowable input powers Win1, Win2.

The control signals to the first and second inverters 22 and 24 and the control signals to the relays are outputted from the system ECU 50. Examples of the relays include a series relay Rs, a first parallel relay Rp1, and a second parallel relay Rp2. The system ECU 50 can communicate with a station electronic control unit (hereinafter, referred to as a “station ECU”) 86 of the charging station 80.

The charging station 80 includes a station connector 82, a power supply device 84, and a station ECU 86. The station connector 82 is configured to be connectable to the charging connector 44 of the power supply system 10. The power supply device 84 is connected to an AC power source such as a household power source or a commercial power source, and is configured to be capable of converting AC power from the AC power source into DC power and adjusting output power (output voltage and output current) so as to be output to the station connector 82 side. The station ECU 86 comprises a microcomputer as well as the system ECU 50. The station ECU 86 receives signals of various sensors. Examples of the various sensors include a voltage sensor (not shown) that detects an output voltage Vs of the power supply device 84, and a current sensor (not shown) that detects an output current Is of the power supply device 84. A control signal to the power supply device 84 is outputted from the station ECU 86. The station ECU 86 is capable of communicating with the system ECU 50 as described above. Examples of the charging station 80 include a first voltage station, a second voltage station, and a third voltage station. In the first voltage station, the voltage of the supplied power is the first voltage Vs1 (e.g., 400 V). The second voltage station is a second voltage Vs2 (e.g., 800 V) whose voltage of the supplied power is higher than the first voltage Vs1. The third voltage station can selectively set either the first voltage Vs1 or the second voltage Vs2 as the voltage of the supplied power.

In the power supply system 10 of the embodiment configured as described above, when the motor 20 is driven as the driving motor, the series relay Rs is turned on and the first parallel relay Rp1 and the second parallel relay Rp2 are turned off. Thus, the first battery 13 and the second battery 14 are connected in series, and the motor 20 is driven by the first inverter 22 using electric power from the first battery 13 and the second battery 14.

In the power supply system 10, the system ECU 50 may be connected to the charging connector 44 and the station connector 82 of the charging station 80. At that time, the parallel charging is selected when the voltage of the supply power of the charging station 80 is the first voltage Vs1, and the series charging is selected when the voltage of the supply power of the charging station 80 is the second voltage Vs2.

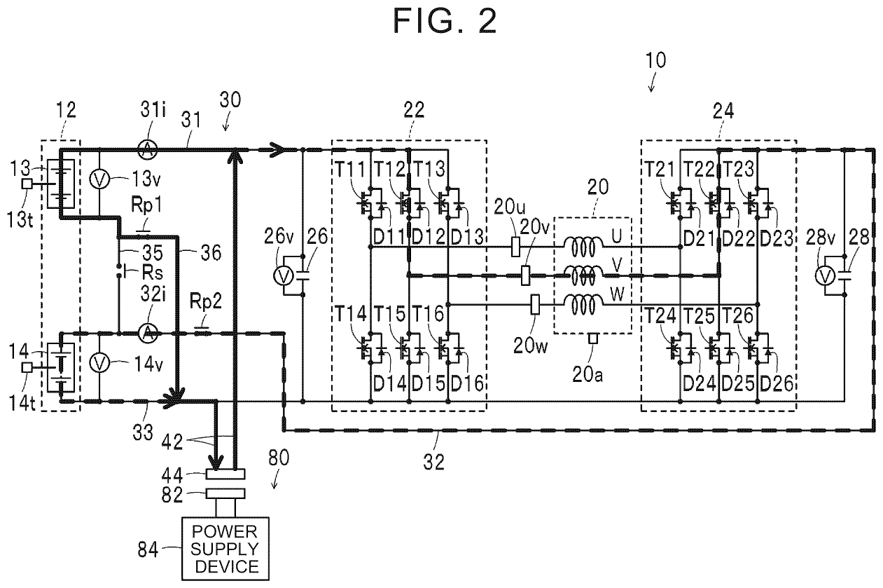

In the parallel charge, the series relay Rs is turned off and the first parallel relay Rp1 and the second parallel relay Rp2 are turned on. Accordingly, the first battery 13 and the second battery 14 are connected in parallel as viewed from the charging connector 44, and the first battery 13 and the second battery 14 are charged using the electric power from the charging station 80. FIG. 2 is an explanatory diagram illustrating a current flow during parallel charging. In the figure, a thick solid line with an arrow indicates a charging current of the first battery 13, and a thick broken line with an arrow indicates a charging current of the second battery 14. In the parallel charging, the first battery 13 is charged by a current flowing from the charging connector 44 to the positive line of the charging line 42, the first positive line 31, the first battery 13, the parallel line 36 (first parallel relay Rp1), the negative line 33, the negative line of the charging line 42, and the charging connector 44 in this order, as shown by a thick solid line with an arrow in FIG. 2. The second battery 14 is charged by a current flowing in the order of the positive line of the charging line 42, the first positive line 31, the first inverter 22, the motor 20, the second inverter 24, the second positive line 32 (second parallel relay Rp2), the second battery 14, the negative line 33, the negative line of the charging line 42, and the charging connector 44 from the charging connector 44, as shown by the thick broken line with arrows in FIG. 2. At this time, the upper arm of the second inverter 24 is turned on and fixed (the lower arm is turned off and fixed), and a step-down control for controlling the duty of the upper arm and the lower arm of the first inverter 22 is executed. Thus, the motor 20 and the first inverter 22 function as a three-phase step-down converter, and the input power of the first inverter 22 is stepped down and output from the motor 20. Further, the upper arm of the first inverter 22 is turned on and fixed (the lower arm is turned off and fixed), and the boost control for controlling the duty of the upper arm and the lower arm of the second inverter 24 is executed. Thus, the motor 20 and the second inverter 24 function as a three-phase boost converter, and the input power of the motor 20 is boosted and output from the second inverter 24.

In the series charge, the series relay Rs is turned on and the first parallel relay Rp1 and the second parallel relay Rp2 are turned off. Thus, the first battery 13 and the second battery 14 are connected in series, and the first battery 13 and the second battery 14 are charged using the electric power from the charging station 80. In the series charging, the first battery 13 and the second battery 14 are charged by the current flowing from the charging connector 44 to the positive line of the charging line 42, the first positive line 31, the first battery 13, the series line 35 (series relay Rs), the second battery 14, the negative line 33, the negative line of the charging line 42, and the charging connector 44 in this order.

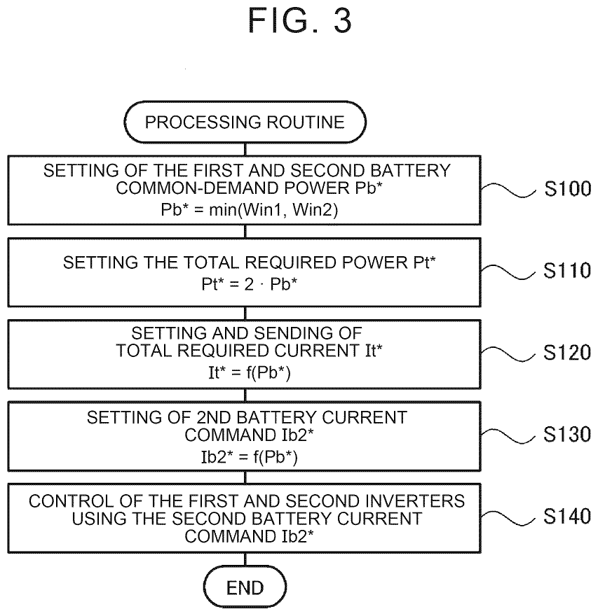

Next, the operation of the power supply system 10 of the embodiment, in particular, the operation at the time of parallel charging will be described. FIG. 3 is a flow chart illustrating a process routine executed by the system ECU 50. This routine is repeatedly executed during parallel charging. The series relay Rs is turned off and the first parallel relay Rp1 and the second parallel relay Rp2 are turned on prior to the repetition of the routine.

When the process routine of FIG. 3 is executed, the system ECU 50 first sets the minimum value of the allowable input powers Win1, Win2 of the first battery 13 and the second battery 14 to the common required power Pb*, which is the common required power of the first battery 13 and the second battery 14 (S100). Subsequently, twice the common required power Pb* is set to the total required power Pt* (S110), and the total required current It* is set based on the set total required power Pt*, and is transmitted to the station ECU 86 of the charging station 80 (S120). The total required current It* is calculated, for example, by dividing the total required power Pt* by the output voltage Vs of the power supply device 84, or by dividing the total required power Pt* by the maxima of the voltages Vb1, Vb2 of the first battery 13 and the second battery 14. Upon receiving the total required current It*, the station ECU 86 controls the power supply device 84 so that a current corresponding to the total required current It* is supplied from the charging station 80 to the power supply system 10.

Then, the current command Ib2* of the second battery 14 is set based on the shared required power Pb* (S130). Then, the first inverter 22 and the second inverter 24 are controlled based on the set current command Ib2* of the second battery 14 (S140), and the routine ends. The current command Ib2* is calculated, for example, by dividing the shared required power Pb* by the voltage Vb2 of the second battery 14. By the control of the first inverter 22 and the second inverter 24, the second battery 14 is charged with a current (power corresponding to the common required power Pb*) corresponding to the total required current It* from the charging station 80 (power corresponding to the total required power Pt*, that is, power corresponding to twice the common required power Pb*) corresponding to the current command Ib2*. The first battery 13 is also charged with a similar current. Therefore, it is possible to suppress a relatively large deviation between the charging current of the first battery 13 (the current Ip1 flowing through the first positive line 31) and the charging current of the second battery 14 (the current Ip2 flowing through the second positive line 32).

The control of the first inverter 22 and the second inverter 24 is performed, for example, as follows. When the open-circuit voltage OCV1 of the first battery 13 is higher than the open-circuit voltage OCV2 of the second battery 14, the step-down control is executed. As a result, a part of the electric power from the charging station 80 is stepped down by the first inverter 22 and the motor 20 and supplied to the second battery 14. Therefore, it is possible to suppress a relatively large deviation between the charging current of the first battery 13 and the charging current of the second battery 14. When the open-circuit voltage OCV1 of the first battery 13 is lower than the open-circuit voltage OCV2 of the second battery 14, the step-up control is executed. As a result, a part of the electric power from the charging station 80 is boosted by the motor 20 and the second inverter 24 and supplied to the second battery 14. It is possible to suppress a relatively large deviation between the charging current of the first battery 13 and the charging current of the second battery 14. When the open-circuit voltage OCV1 of the first battery 13 is equal to the open-circuit voltage OCV2 of the second battery 14, either the step-down control or the step-up control may be executed. Alternatively, both of the upper arms of the first inverter 22 and the second inverter 24 may be fixed on (both of the lower arms may be fixed off). In the latter case, a part of the electric power from the charging station 80 is supplied to the second battery 14 without being voltage-converted by the first inverter 22, the motor 20, and the second inverter 24. Therefore, it is possible to suppress a relatively large deviation between the charging current of the first battery 13 and the charging current of the second battery 14. Note that the voltage Vb1 of the first battery 13 and the voltage Vb2 of the second battery 14 may be used instead of the open-circuit voltage OCV1 of the first battery 13 and the open-circuit voltage OCV2 of the second battery 14.

In the power supply system 10 of the above-described embodiment, the upper arm of the second inverter 24 is basically turned on and fixed (the lower arm is turned off and fixed) during parallel charging. At the same time, a step-down control for controlling the duty of the upper arm and the lower arm of the first inverter 22 or a step-up control for turning on and fixing the upper arm of the first inverter 22 and for controlling the duty of the upper arm and the lower arm of the second inverter 24 is executed. Specifically, the minimum value of the allowable input powers Win1, Win2 of the first battery 13 and the second battery 14 is set to the common required power Pb* of the first battery 13 and the second battery 14, and twice of the set common required power Pb* is set to the total required power Pt*, and the total required current It* based on the total required power Pt* is requested from the charging station 80. At the same time, the step-down control or the step-up control is executed by using the current command Ib2* of the second battery 14 based on the shared required power Pb*. By this control, it is possible to suppress a relatively large deviation between the charging current of the first battery 13 and the charging current of the second battery 14.

In the above-described embodiment, the step-down control or the step-up control is executed on the basis of the magnitude relationship between the open-circuit voltage OCV1 of the first battery 13 and the open-circuit voltage OCV2 of the second battery 14 or the magnitude relationship between the voltage Vb1 of the first battery 13 and the voltage Vb2 of the second battery 14 during the parallel charge. However, in addition to any of these components, the step-down control or the step-up control may be performed based on at least one of the path impedance of the charging path of the first battery 13 (see a thick solid line with an arrow in FIG. 2) and the charging path of the second battery 14 (see a thick broken line with an arrow in FIG. 2), and the current and power from the charging station 80. In this way, it is possible to more appropriately suppress a relatively large deviation between the charging current of the first battery 13 and the charging current of the second battery 14. The current from the charging station 80 in parallel charging may be calculated based on the charging current of the first battery 13 (the current Ip1 flowing through the first positive line 31) and the charging current of the second battery 14 (the current Ip2 flowing through the second positive line 32). Alternatively, the current from the charging station 80 during parallel charging may be obtained by communication from the station ECU 86. The electric power from the charging station 80 at the time of parallel charging may be calculated based on the charging electric power of the first battery 13 and the charging electric power of the second battery 14, or may be obtained by communication from the station ECU 86. The charging power of the first battery 13 may be calculated as the product of the voltage Vb1 of the first battery 13 and the current Ip1, and the charging power of the second battery 14 may be calculated as the product of the voltage Vb2 of the second battery 14 and the current Ip2.

In the above-described embodiment, the total required current It* based on the total required power Pt* is transmitted to the station ECU 86 during the parallel charge, but the present disclosure is not limited thereto. For example, the total required power Pt* may be transmitted to the station ECU 86 during parallel charge. When the station ECU 86 receives the total required power Pt*, it controls the power supply device 84 such that the power corresponding to the total required power Pt** is supplied from the charging station 80 to the power supply system 10.

In the above-described embodiment, the step-down control or the step-up control is executed by using the current command Ib2* of the second battery 14 based on the shared required power Pb* of the first battery 13 and the second battery 14 during the parallel charge, but the present disclosure is not limited thereto. For example, the step-down control or the step-up control may be executed by directly using the shared required power Pb* (without using the current command Ib2*).

The correspondence between the main elements of the embodiments and the main elements of the disclosure described in the column of the means for solving the problem will be described. In the embodiment, the first battery 13 corresponds to the “first battery”, the second battery 14 corresponds to the “second battery”, and the motor 20 corresponds to the “motor”. Further, the first inverter 22 corresponds to the “first inverter”, the second inverter 24 corresponds to the “second inverter”, and the charging connector 44 corresponds to the “charging connector”. The system ECU 50 corresponds to a “control device”. In addition, the series line 35 corresponds to a “series line”, the series relay Rs corresponds to a “series relay”, and the parallel line 36 corresponds to a “parallel line”. Further, the first parallel relay Rp1 corresponds to the “first parallel relay”, and the second parallel relay Rp2 corresponds to the “second parallel relay”.

The correspondence between the main elements of the embodiment and the main elements of the disclosure described in the section of the means for solving the problem is an example for specifically explaining the embodiment of the disclosure described in the section of the means for solving the problem. Therefore, the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of a power supply system and the like.

What is claimed is:

1. A power supply system including a first battery and a second battery, the power supply system comprising:
a motor including a three-phase coil;
a first inverter connected to the first battery via a first positive line and a negative line and connected to one end side of the three-phase coil;
a second inverter connected to the second battery via a second positive line and the negative line and connected to the other end side of the three-phase coil;
a charging connector connected to the first positive line and the negative line and electrically connectable to charging equipment; and
a control device configured to, during parallel charging for charging the first battery and the second battery with electric power from the charging equipment, fix an upper arm of one of the first inverter and the second inverter to an ON state and perform duty control on an upper arm and a lower arm of the other of the first inverter and the second inverter.

2. The power supply system according to claim 1, wherein the control device is configured to, during the parallel charging, set a minimum value of each of first allowable input power of the first battery and second allowable input power of the second battery as common requested power of the first battery and the second battery, set a double of the common requested power as total requested power, request the charging equipment for the total requested power or a total requested current that is based on the total requested power, and control the first inverter and the second inverter using the common requested power or a current command for the second battery that is based on the common requested power.

3. The power supply system according to claim 1, wherein the control device is configured to, during the parallel charging, fix the upper arm of the second inverter to the ON state and perform the duty control on the upper arm and the lower arm of the first inverter when a voltage of the first battery is higher than a voltage of the second battery, and fix the upper arm of the first inverter to the ON state and perform the duty control on the upper arm and the lower arm of the second inverter when the voltage of the first battery is lower than the voltage of the second battery.

4. The power supply system according to claim 1, wherein:
a positive terminal of the first battery is connected to the first positive line;
a negative terminal of the second battery is connected to the negative line;
the power supply system further includes a series line, a series relay, a parallel line, a first parallel relay, and a second parallel relay, the series line connecting a negative terminal of the first battery and a positive terminal of the second battery, the series relay being attached to the series line, the parallel line connecting the series line at a position closer to the first battery than the series relay and the negative line, the first parallel relay being attached to the parallel line, the second parallel relay being attached to the second positive line; and
in the parallel charging, the series relay is turned off and the first parallel relay and the second parallel relay are turned on to connect the first battery and the second battery in parallel as viewed from the charging connector, and the first battery and the second battery are charged with the electric power from the charging equipment.
